(19) United States
(12) Patent Application Publication
(10) Pub. No.: US 2023/0419083 A1
(43) Pub. Date: Dec. 28, 2023

(54) DYNAMIC PROFILE ASSIGNMENT AND ADJUSTMENT FOR CAMERA BASED ARTIFICIAL INTELLIGENCE OBJECT DETECTION

(71) Applicant: Wyze Labs, Inc., Kirkland, WA (US)

(72) Inventors: Shiyuan Niu, Sammamish, WA (US); Lin Chen, Seattle, WA (US); Zhongwei Cheng, Redmond, WA (US); Wenjiang Fan, Kirkland, WA (US); Jing Xue, Menlo Park, CA (US); Tianqiang Liu, Bellevue, WA (US)

(73) Assignee: Wyze Labs, Inc., Kirkland, WA (US)

(21) Appl. No.: 18/328,815

(22) Filed: Jun. 5, 2023

Related U.S. Application Data
(60) Provisional application No. 63/367,056, filed on Jun. 27, 2022.

(51) Int. Cl. G06N 3/0464; G08B 13/196

(52) U.S. Cl. CPC G06N 3/0464; G08B 13/19602

(57) ABSTRACT

A system and method for improving the ability of a camera to detect objects or events occurring within its field of view and to accurately categorize them using Artificial Intelligence (AI) aided by input from users. The camera may include rules for determining when an object has entered its field of view, and for determining what category of object it is. When a new object is detected, an alert may be sent to a user and optionally to an analytics service as well. The user may provide input confirming whether the category of the event was correctly determined, and the analytics service may apply an AI algorithm to determine what, if any, changes should be made to the rule criteria in the camera. Updated rule criteria may be sent back to the camera thus improving its ability to detect objects in the future.

### CROSS-REFERENCE TO RELATED APPLICATION

This application claims the benefit of U.S. Provisional Application No. 63/367,056 filed Jun. 27, 2022 of which is hereby incorporated by reference.

### BACKGROUND OF THE INVENTION

Internet Protocol (IP) cameras often use sensitivity parameters to determine how sensitive the device is to motion. The camera may be configured then to only records video when the detected motion is above the predetermined sensitivity threshold.

This also applies to Artificial Intelligence (AI) detection algorithms that may be used in conjunction with IP cameras. This may apply to AI detection beyond motion detection working with the IP camera, such as person detection, pet detection, package detection and vehicle detection. The AI detection settings can be different for different use cases of IP cameras. For example, package detection is more useful for a video doorbell installed at the front door than an indoor camera installed in the living room, as it makes little sense to detect packages for living room cameras. A street-facing camera can be easily triggered by irrelevant motions from tree moving and may require a lower motion sensitivity, but an entry camera used for security monitoring may need to be highly sensitive to not miss anything.

However, the settings (motion sensitivity, AI detections/sensitivity) are mostly pre-set for each camera and users are required to manually adjust it to the right settings, which is inefficient. For many users, these settings may not be and cannot be tuned to the best case because of the wide diversity of the use cases and the additional human tuning stages.

### SUMMARY OF THE INVENTION

The disclosed system and method provides for Artificial Intelligence (AI) in a motion detection system for a camera such as might be used in a surveillance system. The system includes a camera (e.g. an IP camera) configured with hardware and software that is operable to detect motion within its field of view. The camera may be configured to detect any movement within its field of view and to further use the built in rule criteria to evaluate and categorize the source of the detected movement. The categories may include, but not be limited to, a person, a pet, a vehicle, a package, an emergency vehicle (with or without flashing lights), and the like.

In another aspect, the AI algorithms may be executed separate from the camera by a local computing device, a central server, or any combination thereof. The AI algorithms may be operable to process audio and/or video feeds obtained from one or more cameras thus optionally centralizing the AI processing for multiple cameras. The rule criteria may include a sensitivity setting establishing predetermined thresholds. Motion detected that is below the threshold may be ignored as “background noise”, and motion detected above the threshold may be used to trigger the categorization process.

In another aspect, the system may be configured so that when the user notices that the system has improperly categorized the activity, the system may be configured to accept input from the user to correct the mistake. For example, the system may provide a user interface with a button or other input device indicating a false positive or a false negative result.

In another aspect, the AI algorithms of the present disclosure may be configured to receive the user's input from the user interface and further to use that input to tune the AI algorithm and the accompanying sensitivity settings to obtain a more accurate result in the future. The AI system may include a sensitivity curve and integrate this with user feedback to determine adjustments to the threshold values in the rule criteria to adjust categorization process accordingly. The system may also provide feedback through the user interface indicating to the user that the detection and/or categorization rules have been adjusted and to watch for future improvements.

In another aspect, the camera may be positioned in different areas, and this positioning may be used as input to the AI system. In one example, the camera may be positioned above the area of interest such that the field-of-view captures activities adjacent to an entry door, garage door, or other entrance. In another aspect, the camera may be positioned at or near waist level, such as in the case of a doorbell camera. In another aspect, user input may be used to name the camera according to its intended purpose, and this name may be useful in automatically determining one or more of the predetermined thresholds in the rule criteria.

In another aspect, the AI algorithm of the disclosed system may be configured to use the location of adjacent cameras and settings specific to those cameras as input to making a determination on the necessary adjustments for another camera nearby. In this example, the camera of the present disclosure may be configured to automatically adjust settings across multiple cameras in response to updates made to anyone of the individual cameras.

In another aspect, cameras of the present disclosure may include audio input devices such as microphones configured to detect sound accompanying the obtained images. The rule criteria of the present disclosure may include audio detection and recognition capabilities and may be configured to recognize and categorize different types of audio input. In this way, system of the present disclosure may be configured to categorize the audio input into any suitable categories examples of which include, but are not limited to, a baby crying, a dog barking, people talking, glass breaking, a fire alarm activation, and the like. In another aspect, audio sensitivity settings may be included to establish predetermined thresholds below which the system may ignore sound as “background noise”. This threshold may be determined based on the overall level of the sound detected (i.e. how loud it is).

Further forms, objects, features, aspects, benefits, advantages, and embodiments of the present invention will become apparent from the detailed description, drawings, and claims provided herewith.

### BRIEF DESCRIPTION OF THE DRAWINGS

FIG. 1 is a component diagram illustration components that may be included in a system of the present disclosure.

FIG. 2 is a flow diagram illustrations actions that may be taken by a system of the present disclosure.

### DETAILED DESCRIPTION OF THE INVENTION

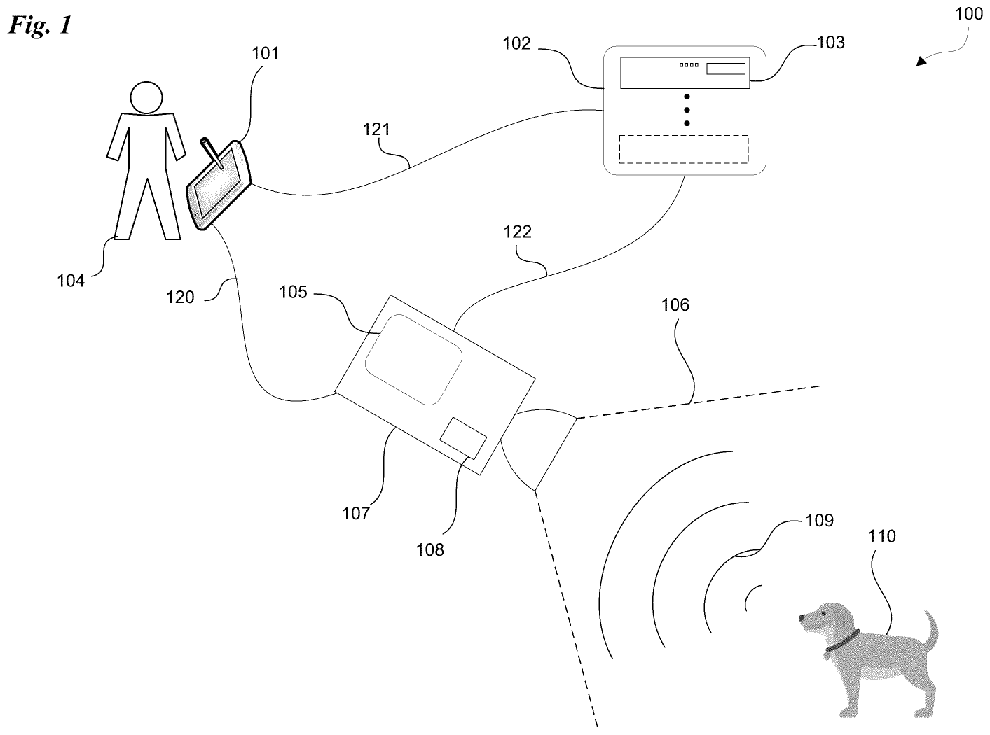

Illustrated in FIG. 1 at 100 is one example of components that may be included in a system of the present disclosure. The system may include a camera 107 operable to capture images within a field-of-view 106 defined by the camera. The camera 107 may include a control circuit 105 which may implement some or all of the control logic which may be useful for operation of the camera. Control circuit 105 may include, or be electrically connected to, a processor, memory, or other logic circuitry, and/or sensors such as may be used to capture sound or light. An input device 108 may be included that is operable to capture audible sounds, some of which may emanate from objects 110 that may, or may not, be within the field-of-view of the camera 107. For example, a pet, a child, a passing vehicle, or other object may be captured by the camera and/or may also generate sound which may be captured by the input device 108 and processed by control circuit 105.

Control circuit 105 may also include configuration settings which may be used by the control logic to make determinations regarding what type of object 110 is within the field-of-view 106. The configuration settings may include one or more rules with criteria or thresholds for determining when image data collected by camera 107 indicates movement has occurred within the cameras field-of-view 106. Similarly, configuration settings optionally include one or more rules with criteria for determining when data captured by input device 108 indicates when activity of interest is occurring adjacent to the camera 107.

In one example, an algorithm with rules maintained by the control circuit 105 may be used to determine when image data retrieved by the camera changes over time, and these changes may be quantified and tracked to determine when changes occurring within the field-of-view 106 exceed predetermined threshold values indicating that movement has occurred. Predetermined values may be assigned on a gradient with predefined maximum minimum values. In one example, no change may be defined as a value of 0.0, while a high degree of change may be assigned a maximum value of 1.0. Threshold values may then be assigned on a gradient between these extremes to specify when enough change has occurred to indicate movement.

In another aspect, the camera 107 may capture multiple individual frames over time such as at the rate of 30 frames per second, or 60 frames per second, or any other suitable rate. The control circuit 105 of the camera may be configured to present the individual frames captured by the camera as input to the algorithm to determine if movement has occurred, and optionally to determine a category for the events taking place. Algorithm may, for example, compare the pixels at or near corresponding positions of the individual frames for one or more successive frames to determine if the pixel data has changed according to the criteria in the rules. These individual pixel “deltas” may be grouped together, filtered, and/or compared over time to determine whether the changes in the pixel data are sufficient to trigger an alert that movement has been detected, and they may also be used to determine a category for the activity that has occurred. The overall result of these comparisons may be assigned a value according to the predetermined gradients between a maximum minimum value. An alert notification may be sent if levels are above the predefined triggering thresholds specified in the rules.

For example, a camera positioned at a garage door may be mounted at a high angle and positioned with a field-of-view of the parking area adjacent the garage door. The parking area that is within the field-of-view of the camera may change very little over time except when a vehicle passes, or stops within the cameras field-of-view. As the vehicle enters the field-of-view, the pixel data within the frames captured by the camera shifts from the nominal black or gray colors of the parking lot to accommodate the color and shape of the vehicle. A small change of a few pixels may be insufficient to trigger an alert, but a growing number of pixels changing rapidly within a few frames, or an overall increase in the number of pixels that have changed may be sufficient to trigger an alert that movement has occurred. The changing pixel data may also be used to determine that the object in the field of view is a car, and not a person, or animal, etc.

The rules may include criteria for determining not only that motion is occurred, but that a particular type of activity is taking place, or particular type of object is within the field-of-view of the camera. Control circuit 105 may be configured with pattern recognition algorithms operable to detect packages, faces, animals, vehicles, and the like. These pattern recognition algorithms may include multiple predetermined matching criteria specific to individual portions of the image, or to the image overall, or to specific configurations of shapes or arrangements of shadows, or other image features. Any suitable method for determining the type of objects within the field-of-view of the camera may be useful by the rule criteria for categorizing objects appearing, disappearing, or otherwise moving within the field-of-view 106.

A similar process may be implemented by the camera 107 with respect to auditory information collected by input device 108. Audible sounds may be captured by the input device and processed by control circuit 105 to define a normal set of “background” sounds. These background sounds may then be compared against the incoming data stream of audible noises, and the differences between the two may be useful in determining if a sound is occurring that warrants sending an alert. For example, a significant increase in the volume of sound may be encoded as a threshold value in a rule which if achieved, may be sufficient to trigger an alert.

In another aspect, particular types of sounds may be discernible by the control circuit 105 Certain patterns or categories of sound input such as a baby crying, dog barking, siren, and the like, may be stored in control circuit 105 and may be used as threshold values for criteria for one or more rules. When a sound data captured by input device 108 matches or closely approximates one of the previously categorized patterns, a rule may be triggered causing an alert to be sent.

When an alert is sent, it may be captured by any device in communication with camera 107. For example, camera 107 may be configured to establish and maintain one or more communication links 120-122 by which alerts may be communicated to other devices. One such device is a computing device 101 such as a tablet computer, smart phone, desktop computer, laptop, and the like. Device 101 may be programmed and configured to accept alerts sent by camera 107 and to present alert specific information via a user interface so that a user 104 may be notified and may optionally respond. The user interface may be configured to provide access to the input that caused the alert such as a brief.

The notification may include information about the alert such as whether the alert was triggered based on auditory or visual information, and/or the category of the alert. The category of the alert may be determined by the rules configured in the control circuit 105. A single alert may include multiple categories. For example, camera 107 may send an alert that an emergency vehicle has moved within the cameras field-of-view. Separate rules may have been triggered in this situation with one rule indicating that the image data received by the camera has changed sufficiently to indicate motion has been detected, and that the motion was caused by a vehicle (and not another object). Auditory data received by the input device of the camera may match a predetermined pattern for the sound of a siren thus indicating further that the vehicle is an emergency vehicle.

In another aspect, alerts may be delivered to a data analytics service 102. The analytics service 102 may be implemented using a single computing device, or may be configured to include multiple computing devices 103. The analytics service may be configured to accept the image and sound data from camera 107, and/or multiple others like it. The computing devices 103 may be programmed and configured to analyze data obtained from the camera and to process the data to adjust the threshold values in the rule criteria for one or more of the cameras 107. In this way, the accuracy of the cameras may be improved. In one aspect, the algorithms executed by one or more processors of the data analytics service may be AI algorithms which may include, but are not limited to a neural network, a convolutional neural network, a deep learning algorithm, or other AI system.

In another aspect, user input may be obtained via an input device of computing device 101 when an alert is presented to the computing device 101. The user may also be presented with visual and/or auditory output from camera 107. The user may be given the option to specify whether the category that was determined by the rules in control circuit 105 matches the image/sound output of the camera. For example, a rule in control circuit 105 may be triggered based on image data indicating that a package has been delivered. The resulting alert may be presented to user 104 (via computing device 101) and may include an image, and/or a video feed, from camera 107. Upon inspecting the image, the user 104 may determine that the object 110 that is presently within the field-of-view 106 of camera 107 is not a package but is instead a wild animal, or a person, etc.

The user interface presented by computing device 101 may offer an option to indicate that the category is incorrect. This input provided by the user may be obtained by the data analytics service 102 and compared with the alert and the image and/or sound data obtained from camera 107. The data analytics service 102 a be configured to adjust one or more of the rule criteria threshold values accordingly to better match the most recent results. These newly calculated values may be sent back to camera 107 and automatically installed in control circuit 105 so that future categorizations may be more accurate. In another aspect, the user interface provided by computing device 101 may include the option to specify that an alert should have been initiated when it wasn't thus indicating to the data analytics service 102 that other adjustments should be made to the rule criteria values to capture events that may currently otherwise be ignored. In this way, the system of the present disclosure may automatically detect and categorize events, and may over time, become more and more precise in categorizing the type of event that has occurred.

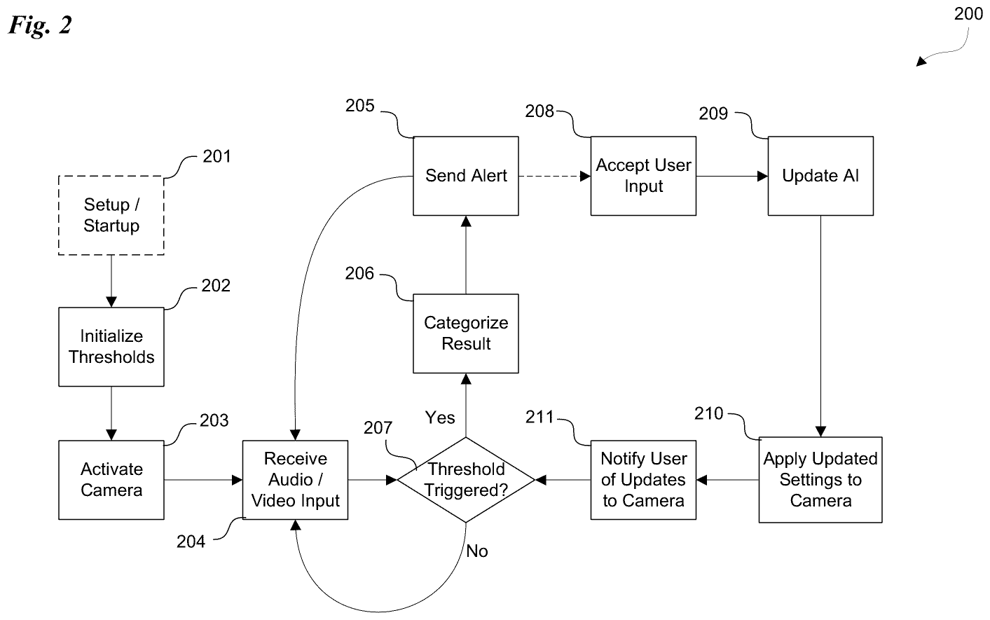

Illustrated in FIG. 2 at 200 is one example of the disclosed method for detecting and categorizing movement, and for optionally making the detection process more accurate based on user input. At 201, an initial setup or start up process may be initiated, such as when the camera is first installed, or first activated after being turned off.

At 202, threshold values for the various rule criteria may be initialized with default values. The initialization process optionally includes accepting input from a user indicating the general purpose of the camera, the general position of the camera, or optionally a name for the camera (e.g. “rear porch”, “side doorbell”, “backyard”). In another aspect, the control circuitry in the camera may include algorithms for automatically determining an initial set of default rule criteria based on the name or position for the camera. Input from the user may be collected via a user interface such as might be provided by an application executed by computing device such as a tablet, smart phone, and the like. In another aspect, the cameras of the present disclosure may communicate initial threshold values to each other, or the initial threshold values may be communicated from the data analytics service of the present disclosure.

The camera may be activated at 203 and may begin receiving video and/or audio input at 204. When one of the rules installed in a camera is triggered at 207, the control circuit may determine the category of the activity based on rule criteria at 206, and a corresponding alert may be sent at 205 with information about the alert such as the category and optionally a portion of the input received from the camera that caused the alert. The alert may be captured by the data analytics service, and/or by the computing device operated by a user.

The user may optionally provide input indicating whether the alert was accurate in categorizing the event that caused the alert to be sent. This user input may be captured at 208 and it may be then processed by the data analytics service at 209 to update the artificial intelligence algorithm of the present disclosure with new threshold values for the rules in the camera. The updated settings may be sent to the camera at 210 and applied automatically, and the data analytics system may notify the user at 211 that updated settings have been installed in the camera.

The concepts illustrated and disclosed herein are optionally arranged and configured according to any of the following non-limiting numbered examples:

Example 1: A method, comprising obtaining image data from a camera defining a field of view.

Example 2: The method of any preceding example, wherein the image data includes one or more separate images taken at different points in time.

Example 3: The method of any preceding example, including using a control circuit of the camera to determine when an object has moved into the field of view of the camera.

Example 4: The method of any preceding example, including determining a category for the object using one or more rules with criteria specifying multiple different categories of objects.

Example 5: The method of any preceding example, including sending an alert to a computing device when the object moves within the field of view indicating the category of the object.

Example 6: The method of any preceding example, including sending the category and one or more of the separate images to a personal computing device, wherein the personal computing device is configured to present a user interface that provides access to the separate images and the category.

Example 7: The method of any preceding example, including accepting user input from a user indicating that the image data matches the category determined by the control circuit.

Example 8: The method of any preceding example, including sending one or more of the separate images, the category, and user input indicating whether the image data matches the category to a data analytics service via a communication link.

Example 9: The method of any preceding example, including using a data analytics service to determine updated rule criteria for at least one of the rules specifying different categories of objects.

Example 10: The method of any preceding example, wherein a data analytics service uses the image data provided by the camera, a category determined by a control circuit, and user input to determine updated rule criteria.

Example 11: The method of any preceding example, including comparing pixel data from one of the separate images to corresponding pixel data from another different one of the separate images.

Example 12: The method of any preceding example, including comparing regions from one of the separate images to one or more predetermined image patterns stored in a memory of the control circuit.

Example 13: The method of any preceding example, including obtaining sound data from an input device of the camera, wherein the sound data includes sound data obtained from the input device at different points in time.

Example 14: The method of any preceding example, including using a control circuit of the camera to compare the sound data with rule criteria in the control circuit to determine an event category, wherein the rule criteria specifies one or more categories of events.

Example 15: The method of any preceding example, including sending the event category and at least a portion of sound data captured by the camera to a personal computing device, wherein the personal computing device is configured to present a user interface that provides access to the sound data and the category.

Example 16: The method of any preceding example, including accepting user input from a user indicating that sound data captured by the camera matches a category determined by the control circuit.

Example 17: The method of any preceding example, including using a data analytics service to determine updated rule criteria for at least one of the rules specifying different categories of objects.

Example 18: The method of any preceding example, wherein a data analytics service uses sound data captured by the camera, a category determined by the control circuit, a user input to determine updated rule criteria.

Example 19: The method of any preceding example, including comparing regions from sound data captured by the camera to one or more predetermined audio input patterns stored in a memory of the control circuit.

Example 20: The method of any preceding example, wherein the camera is mounted adjacent to a door.

Example 21: The method of any preceding example, wherein the camera is mounted in a doorbell mechanism.

Example 22: The method of any preceding example, wherein the rule criteria include threshold values ranging between 0.0 and 1.0.

Example 23: The method of any preceding example, wherein the control circuit includes a processor, memory, and communication circuits operable to establish and maintain one or more communication links.

Example 24: The method of any preceding example, wherein the control circuit is operable to maintain one or more wireless or wired communication links with one or more other computing devices via a computer network.

Example 25: The method of any preceding example, wherein the camera is an IP camera.

Example 26: The method of any preceding example, wherein a data analytics service is in communication with the control circuit and is operable to analyze image or audio data provided by the camera using artificial intelligence.

Example 27: The method of any preceding example, wherein a data analytics service is in communication with the control circuit and is operable to analyze image or audio data provided by the camera using a neural network.

Example 28: The method of any preceding example, wherein the rule criteria optionally includes one or more predetermined image patterns and/or one or more predetermined audio input patterns.

Example 29: The method of any preceding example, wherein a data analytics service is in communication with the control circuit and is operable to analyze image or audio data provided by the camera using a convolutional neural network.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“And/or” is inclusive here, meaning “and” as well as “or”. For example, “P and/or Q” encompasses, P, Q, and P with Q; and, such “P and/or Q” may include other elements as well.

“Artificial Intelligence” generally refers to using a computer algorithm, or set of instructions, to simulate human intelligence processes by computer systems. Specific applications of AI include expert systems, natural language processing, speech recognition and machine vision.

“Camera” generally refers to an apparatus or assembly that records images of a viewing area or field-of-view on a medium or in a memory. The images may be still images comprising a single frame or snapshot of the viewing area, or a series of frames recorded over a period of time that may be displayed in sequence to create the appearance of a moving image. Any suitable media may be used to store, reproduce, record, or otherwise maintain the images.

“Controller” or “control circuit” generally refers to a mechanical or electronic device configured to control the behavior of another mechanical or electronic device. A controller or “control circuit” is optionally configured to provide signals or other electrical impulses that may be received and interpreted by the controlled device to indicate how it should behave.

“Communication Link” generally refers to a connection between two or more communicating entities and may or may not include a communications channel between the communicating entities. The communication between the communicating entities may occur by any suitable means. For example the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Convolutional Neural Network (CNN)” generally refers to a type of artificial neural network used in image recognition and processing that is specifically optimized to process pixel data to search for patterns.

A CNN typically uses multiple layers of computational nodes that are organized to reduce the processing time and computational power required to recognize patterns in larger images. The layers of a CNN optionally consist of an input layer, an output layer and a hidden layer that may include multiple convolutional layers, pooling layers, fully connected layers and normalization layers. The removal of limitations and increase in efficiency for image processing results in a system that is generally more effective and simpler to train, but is sometimes limited to image processing and natural language processing.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the D22 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Display device” generally refers to any device capable of being controlled by an electronic circuit or processor to display information in a visual or tactile. A display device may be configured as an input device taking input from a user or other system (e.g. a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Neural Network” generally refers to a collection of cooperating computational nodes implemented in hardware and/or software that use a mathematical or computational model for information processing based on a connectionistic approach to computation. A neural network may be an adaptive system that changes its structure based on external or internal information that flows through the network. The connections between nodes may be “weighted” to achieve specific outcomes given a wide range of inputs. A more positive weight reflects a more relevant or more “excitatory” connection, while a more negative weight reflects a more uninteresting or more “inhibitory” connections. All inputs to each node are modified according to the weights and summed. This activity is referred to as a linear combination. Finally, an activation function is generally used by each node to control the amplitude of the output. For example, an acceptable range of output is usually between 0 and 1, or it could be −1 and 1. The output of each node may then be fed as input to other nodes, and thus the overall network of nodes may be able to solve complex problems and/or to adapt to changes in the input over time.

These artificial networks may be used for predictive modeling, adaptive control and applications where they can be trained via a dataset. Self-learning resulting from experience can occur within networks, which can derive conclusions from a complex and seemingly unrelated set of information.[2]

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eye glasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qalcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Receive” generally refer system be sent to the monitoring system s to accepting something transferred, communicated, conveyed, relayed, dispatched, or forwarded. The concept may or may not include the act of listening or waiting for something to arrive from a transmitting entity. For example, a transmission may be received without knowledge as to who or what transmitted it. Likewise the transmission may be sent with or without knowledge of who or what is receiving it. To “receive” may include, but is not limited to, the act of capturing or obtaining electromagnetic energy at any suitable frequency in the electromagnetic spectrum. Receiving may occur by sensing electromagnetic radiation. Sensing electromagnetic radiation may involve detecting energy waves moving through or from a medium such as a wire or optical fiber. Receiving includes receiving digital signals which may define various types of analog or binary data such as signals, datagrams, packets and the like.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if (clouds.areGrey( ) and
(clouds.numberOfClouds > 100) ) then {
  prepare for rain;
} else {
  Prepare for sunshine;
}
```

“Sensor” generally refers to a transducer whose purpose is to sense or detect a property or characteristic of the environment. Sensors may be constructed to provide an output corresponding to the detected property or characteristic, such output may be an electrical or electromagnetic signal, a mechanical adjustment of one part in relation to another, or a changing visual cue such as rising or falling mercury in a thermometer. A sensor's sensitivity indicates how much the sensor's output changes when the property being measured changes.

A few non-limiting examples of sensors include: Pressure sensors, ultrasonic sensors, humidity sensors, gas sensors, Passive Infra-Red (PIR) motion sensors, acceleration sensors (sometimes referred to as an “accelerometer”), displacement sensors, and/or force measurement sensors. Sensors may be responsive to any property in the environment such as light, motion, temperature, magnetic fields, gravity, humidity, moisture, vibration, pressure, electrical fields, sound, stretch, the concentration or position of certain molecules (e.g. toxins, nutrients, and bacteria), or the level or presence of metabolic indicators, such as glucose or oxygen.

“Transmit” generally refers to causing something to be transferred, communicated, conveyed, relayed, dispatched, or forwarded. The concept may or may not include the act of conveying something from a transmitting entity to a receiving entity. For example, a transmission may be received without knowledge as to who or what transmitted it. Likewise the transmission may be sent with or without knowledge of who or what is receiving it. To “transmit” may include, but is not limited to, the act of sending or broadcasting electromagnetic energy at any suitable frequency in the electromagnetic spectrum. Transmissions may include digital signals which may define various types of binary data such as datagrams, packets and the like. A transmission may also include analog signals.

Information such as a signal provided to the transmitter may be encoded or modulated by the transmitter using various digital or analog circuits. The information may then be transmitted. Examples of such information include sound (an audio signal), images (a video signal) or data (a digital signal). Devices that contain radio transmitters include radar equipment, two-way radios, cell phones and other cellular devices, wireless computer networks and network devices, GPS navigation devices, radio telescopes, Radio Frequency Identification (RFID) chips, Bluetooth enabled devices, and garage door openers.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“Wi-Fi” generally refers to a family of wireless network protocols that are based on the IEEE 802.11 family of standards. Wi-Fi networks are commonly used for local area networking of devices so that these devices may communicate with each other and with a broader computer network such as the Internet. Wi-Fi protocols define how enabled devices may exchange data wirelessly via radio waves. Wi-Fi wireless connections may be useful for providing wireless communications links between desktop and laptop computers, cameras, tablet computers, smartphones, smart TVs, printers, smart speakers, and the like with wireless network access devices to connect them to the Internet.

Wi-Fi uses multiple parts of the IEEE 802 protocol family and is designed to be operable seamlessly with wired communication protocols, such as Ethernet. Compatible devices can network through wireless access points to each other as well as to wired devices and the Internet. The different versions of Wi-Fi are specified by various IEEE 802.11 protocol standards, with different radio technologies determining radio bands, and the maximum ranges, and data rates that may be achieved. For example, Wi-Fi uses the 2.4 gigahertz (120 mm wavelength) UHF and 5 gigahertz (60 mm wavelength) SHF radio bands, which may be subdivided into multiple channels.

The radio frequencies typically used by Wi-Fi transmitters and receivers have relatively high absorption rates and work best for line-of-sight communication links. Many common obstructions such as walls, pillars, home appliances, etc. may greatly reduce range, but interference between different networks in crowded environments is usually minimal. In one example, a Wi-Fi network access point may have a range of about 65 feet indoors, or as much as 500 feet outdoors. Wireless network access points may include a single transmitter/receiver to cover a single room to a multiple transmitters/receivers spread over square miles of area to provide overlapping access to client devices.

“User Interface” generally refers an aspect of a device or computer program that provides a means by which the user and a device or computer program interact, in particular by coordinating the use of input devices and software. A user interface may be said to be “graphical” in nature in that the device or software executing on the computer may present images, text, graphics, and the like using a display device to present output meaningful to the user, and accept input from the user in conjunction with the graphical display of the output.

“Viewing Area”, “Field of View”, or “Field of Vision” is the extent of the observable world that is seen at any given moment. In case of optical instruments, cameras, or sensors, it is a solid angle through which a detector is sensitive to electromagnetic radiation that include light visible to the human eye, and any other form of electromagnetic radiation that may be invisible to humans.

What is claimed is:

1. A method, comprising:
obtaining image data from a camera defining a field of view, wherein the image data includes one or more separate images taken at different points in time;
using a control circuit of the camera to determine when an object has moved into the field of view of the camera;
determining a category for the object using one or more rules with criteria specifying multiple different categories of objects; and
sending an alert to a computing device when the object moves within the field of view indicating the category of the object.

2. The method of claim 1, comprising:
sending the category and one or more of the separate images to a personal computing device, wherein the personal computing device is configured to present a user interface that provides access to the separate images and the category.

3. The method of claim 1, comprising:
accepting user input from a user indicating that the image data matches the category determined by the control circuit.

4. The method of claim 1, comprising:
sending one or more of the separate images, the category, and user input indicating whether the image data matches the category to a data analytics service via a communication link.

5. The method of claim 1, comprising:
using a data analytics service to determine updated rule criteria for at least one of the rules specifying different categories of objects, wherein the data analytics service uses the image data provided by the camera, the category determined by the control circuit, and user input to determine the updated rule criteria.

6. The method of claim 1, comprising:
comparing pixel data from one of the separate images to corresponding pixel data from another different one of the separate images.

7. The method of claim 1, comprising:
comparing regions from one of the separate images to one or more predetermined image patterns stored in a memory of the control circuit.

8. The method of claim 1, comprising:
obtaining sound data from an input device of the camera, wherein the sound data includes sound data obtained from the input device at different points in time; and
using a control circuit of the camera to compare the sound data with rule criteria in the control circuit to determine an event category, wherein the rule criteria specifies one or more categories of events.

9. The method of claim 8, comprising:
sending the event category and at least a portion of sound data captured by the camera to a personal computing device, wherein the personal computing device is configured to present a user interface that provides access to the sound data and the category.

10. The method of claim 1, comprising:
accepting user input from a user indicating that sound data captured by the camera matches a category determined by the control circuit.

11. The method of claim 1, comprising:
using a data analytics service to determine updated rule criteria for at least one of the rules specifying different categories of objects, wherein the data analytics service uses sound data captured by the camera, the category determined by the control circuit, and user input to determine the updated rule criteria.

12. The method of claim 1, comprising:
comparing regions from sound data captured by the camera to one or more predetermined audio input patterns stored in a memory of the control circuit.

13. The method of claim 1, wherein the camera is mounted adjacent to a door.

14. The method of claim 1, wherein the camera is mounted in a doorbell mechanism.

15. The method of claim 5, wherein the rule criteria include threshold values ranging between 0.0 and 1.0.

16. The method of claim 1, wherein the control circuit includes a processor, memory, and communication circuits operable to establish and maintain one or more communication links.

17. The method of claim 1, wherein the control circuit is operable to maintain one or more wireless or wired communication links with one or more other computing devices via a computer network.

18. The method of claim 1, wherein the camera is an IP camera.

19. The method of claim 1, wherein a data analytics service is in communication with the control circuit and is operable to analyze image or audio data provided by the camera using artificial intelligence.

20. The method of claim 1, wherein a data analytics service is in communication with the control circuit and is operable to analyze image or audio data provided by the camera using a neural network.

21. The method of claim 5, wherein the rule criteria optionally includes one or more predetermined image patterns and/or one or more predetermined audio input patterns.

22. The method of claim 1, wherein a data analytics service is in communication with the control circuit and is operable to analyze image or audio data provided by the camera using a convolutional neural network.
